(19) United States
(12) Patent Application Publication
(10) Pub. No.: US 2022/0319317 A1
(43) Pub. Date: Oct. 6, 2022

(54) DRIVING ASSIST APPARATUS

(71) Applicant: Honda Motor Co., Ltd., Tokyo (JP)

(72) Inventor: Hiroshi Kamakura, Wako-shi (JP)

(21) Appl. No.: 17/676,291

(22) Filed: Feb. 21, 2022

(30) Foreign Application Priority Data
Mar. 30, 2021 (JP) 2021-056567

(51) Int. Cl. G08G 1/0967; G08G 1/09; B60W 40/105; B60W 40/04; B60W 40/12; B60W 50/14; H04W 4/46

(52) U.S. Cl. CPC G08G 1/096783; G08G 1/091; B60W 40/105; B60W 40/04; B60W 40/12; B60W 50/14; H04W 4/46; B60W 2554/4041; B60W 2554/80; B60W 2756/10

(57) ABSTRACT

A driving assist apparatus including a communication unit and a microprocessor. The microprocessor is configured to perform acquiring traffic light information, position information, and rearward vehicle information including length information of a rearward vehicle, calculating an entire length from a front end of a subject vehicle to a rear end of the rearward vehicle based on the length information, deriving a driving assist information including a target vehicle speed or a target acceleration of the subject vehicle so that a group of vehicles including the subject vehicle and the rearward vehicle passes through a point where a traffic light is provided based on the traffic light information, the position information and the entire length, and transmitting a subject vehicle information indicating that the subject vehicle has a driving assist function capable of deriving the driving assist information to the rearward vehicle through the communication unit.

### CROSS-REFERENCE TO RELATED APPLICATION

This application is based upon and claims the benefit of priority from Japanese Patent Application No. 2021-056567 filed on Mar. 30, 2021, the content of which is incorporated herein by reference.

### BACKGROUND OF THE INVENTION

### Field of the Invention

This invention relates to a driving assist apparatus that assists a driver in driving.

### Description of the Related Art

As this type of device, there have been conventionally known an apparatus that notifies a start timing of an accelerator-off operation to the driver of a vehicle traveling on a road with a traffic light, based on traffic light information received by the vehicle. Such a device is disclosed, for example, in Japanese Unexamined Patent Publication No. 2014-096016 (JP2014-096016A). In the apparatus described in JP2014-096016A, the driver is notified of the timing of a deceleration operation through the display unit so that the vehicle can pass through the intersection with a traffic light without stopping.

However, if the subject vehicle that has a driving assist function based on traffic light information is followed by a rearward vehicle without such a driving assist function, when the subject vehicle decelerates based on the traffic light information, the driver of the rearward vehicle may feel a sense of strangeness.

### SUMMARY OF THE INVENTION

An aspect of the present invention is a driving assist apparatus including a communication unit, and an electronic control unit including a microprocessor and a memory connected to the microprocessor. The microprocessor is configured to perform: acquiring a traffic light information including a change information of a traffic light through the communication unit; acquiring a position information indicating a position of a subject vehicle with respect to the traffic light; acquiring a rearward vehicle information including a length information of a rearward vehicle traveling behind the subject vehicle through the communication unit; calculating an entire length from a front end of the subject vehicle to a rear end of the rearward vehicle, based on the length information of the rearward vehicle; deriving a driving assist information including a target vehicle speed or a target acceleration of the subject vehicle so that a group of vehicles including the subject vehicle and the rearward vehicle passes through a point where the traffic light is provided or stops in front of the point, based on the traffic light information, the position information and the entire length; and transmitting a subject vehicle information indicating that the subject vehicle has a driving assist function capable of deriving the driving assist information, to the rearward vehicle through the communication unit.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example of a travel scene of a vehicle having a driving assist apparatus according to an embodiment of the present invention;

FIG. 2A is a plane view schematically illustrating an example of a travel scene of the vehicle having the driving assist apparatus according to the embodiment of the present invention;

FIG. 2B is a plane view schematically illustrating another example of a travel scene of the vehicle having the driving assist apparatus according to the embodiment of the present invention;

FIG. 3 is a block diagram illustrating a configuration of a substantial part of the driving assist apparatus according to the embodiment of the present invention;

FIG. 4 is a diagram illustrating an example of an operation of the vehicle having the driving assist apparatus according to the embodiment of the present invention; and

FIG. 5 is a flowchart illustrating an example of a processing executed by a controller in FIG. 3.

### DETAILED DESCRIPTION OF THE INVENTION

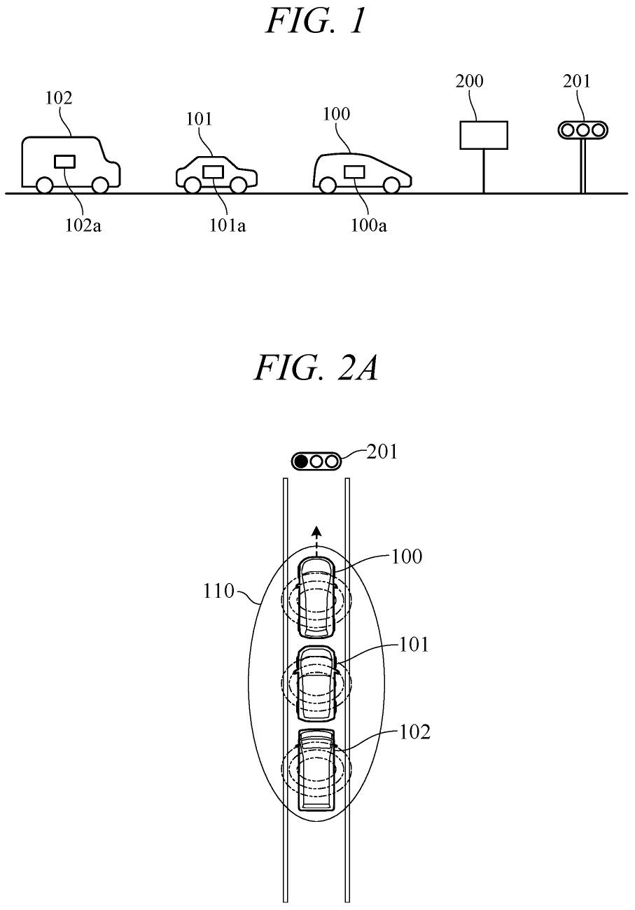

Hereinafter, an embodiment of the present invention will be described with reference to FIGS. 1 to 5. FIG. 1 is a diagram illustrating an example of a travel scene of a vehicle (referred to as subject vehicle to be distinguished from other vehicles) having a driving assist apparatus according to the present embodiment. As illustrated in FIG. 1, the subject vehicle 100 includes a vehicle-mounted device 100a. The vehicle-mounted device 100a has a driving assist function of acquiring, from a communication device 200 provided on the road, traffic light information such as change information of a traffic light 201 installed in front of the communication device 200, and providing the driver with target vehicle speed information and the like based on the traffic light information.

The target vehicle speed information includes information on a target vehicle speed range and a target acceleration at which the subject vehicle 100 can pass through the intersection where the traffic light 201 is installed without stopping, or information on a target deceleration for the subject vehicle 100 to smoothly stop in front of the traffic light 201. The traffic light is configured to sequentially switch between red light indicating a stop instruction, blue light indicating that traveling is possible, and yellow light indicating that traveling is possible but safe stop is difficult, at a predetermined cycle. The traffic light may be an arrow traffic light indicating a direction in which the vehicle can travel with an arrow.

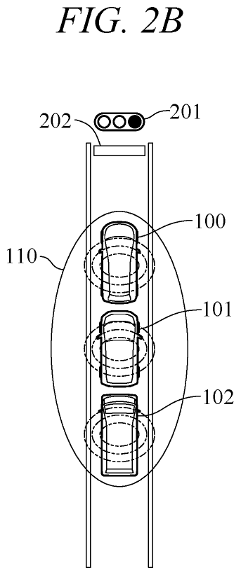

The vehicle-mounted device 100a is communicable with each of vehicle-mounted devices 101a and 102a of other vehicles around the subject vehicle 100, particularly rearward vehicles 101, 102 traveling behind the subject vehicle 100 via a communication unit, that is, is capable of inter-vehicle communication. FIGS. 2A and 2B are plan views each illustrating an example of a traveling scene of the subject vehicle 100. In particular, FIG. 2A illustrates an example in which the traffic light 201 in front of the subject vehicle 100 is blue and the subject vehicle 100 passes through the intersection where the traffic light 201 is installed, and FIG. 2B illustrates an example in which the traffic light 201 is red and the subject vehicle 100 is about to stop at a stop line 202 in front of the traffic light 201.

As illustrated in FIGS. 2A and 2B, the rearward vehicles 101, 102 are located behind the subject vehicle 100 on the same lane as the subject vehicle 100 and follow the subject vehicle 100. For example, the rearward vehicles 101, 102 are vehicles that follow a forward vehicle while maintaining a predetermined inter-vehicle distance from the forward vehicle. The subject vehicle 100 is a forward vehicle for the rearward vehicle 101, and the rearward vehicle 101 is a forward vehicle for the rearward vehicle 102.

FIGS. 2A and 2B schematically illustrate a situation in which the subject vehicle 100 and the rearward vehicles 101, 102 located within a predetermined distance from each other perform inter-vehicle communication by two-dot chain lines. The rearward vehicles 101, 102 have a function of performing inter-vehicle communication, but do not have a function of acquiring traffic light information from the communication device 200 unlike the subject vehicle 100.

The number of rearward vehicles 101, 102 following the subject vehicle 100 is not limited to two and may be one or three or more. For example, all vehicles that travel on the same lane as the subject vehicle 100, are provided to be capable of inter-vehicle communication with the subject vehicle 100, and are located within a first predetermined distance from the subject vehicle 100 are rearward vehicles. A sequence of vehicles following the subject vehicle 100 within a second predetermined distance from the forward vehicle may be set as rearward vehicles. All the subject vehicle 100 and the rearward vehicles 101, 102, that is, a single group of the subject vehicle 100 and the rearward vehicles 101, 102 will be referred to as a vehicle group 110.

The subject vehicle 100 has a driving assist function of notifying a target vehicle speed or the like based on traffic light information, and thus the subject vehicle 100 can travel with prediction of change in the traffic light 201. For example, even if the traffic light 201 ahead is currently blue, when the traffic light 201 is changed from blue to yellow before the subject vehicle 100 reaches the point where the traffic light 201 is installed, a command for deceleration of the subject vehicle 100 is issued. The driver performs a deceleration operation in accordance with this command, so that the subject vehicle 100 can be smoothly decelerated.

On the other hand, since the rearward vehicles 101, 102 do not have such a driving assist function, when the subject vehicle 100 ahead decelerates although the traffic light 201 ahead is blue, the drivers of the rearward vehicles 101, 102 may feel a sense of strangeness. Therefore, in order to prevent the drivers of the rearward vehicles 101, 102 from feeling a sense of strangeness, a driving assist apparatus in the present embodiment is configured as follows.

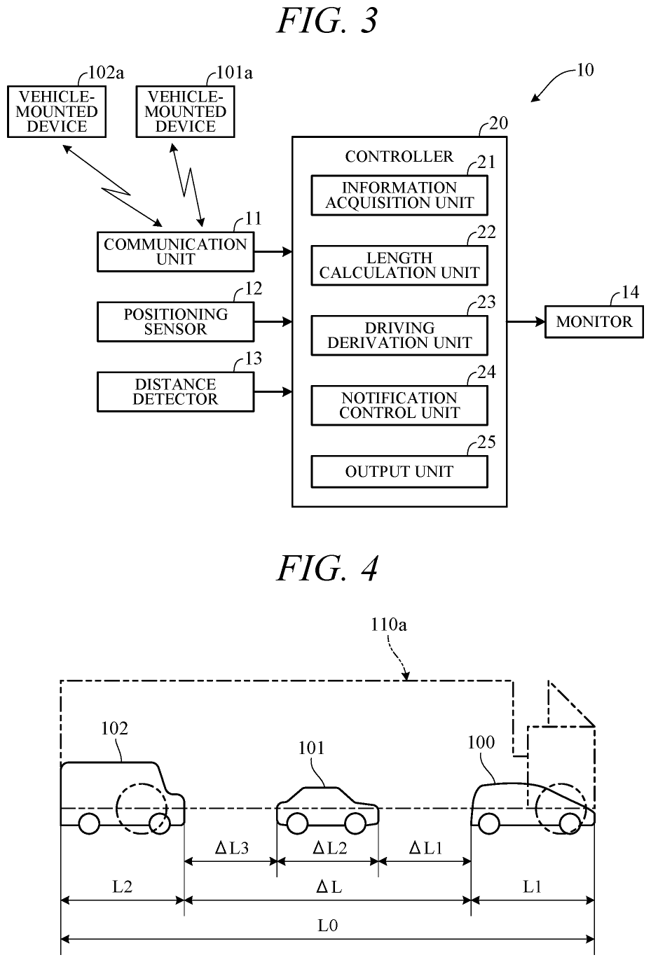

FIG. 3 is a block diagram illustrating a configuration of a main part of a driving assist apparatus 10 according to the present embodiment. The driving assist apparatus 10 is formed of the vehicle-mounted device 100a illustrated in FIG. 1. As illustrated in FIG. 3, the driving assist apparatus 10 includes a controller 20 as the main component, and includes a communication unit 11, a positioning sensor 12, a distance detector (distance detection device) 13, and a monitor 14, which are each communicably connected to the controller 20.

The communication unit 11 is capable of wirelessly communicating with the communication device 200 such as an optical beacon or a radio wave beacon provided on a road, that is, is capable of road-to-vehicle communication. Specifically, the communication unit 11 receives, from the communication device 200 provided on the road, traffic light information on the traffic light 201 located in the traveling direction of the subject vehicle 100, that is, the traffic light 201 installed at the intersection through which the subject vehicle 100 will pass next. The traffic light information includes position information of the traffic light 201 and information on change time of a light color of the traffic light 201. The information on change time includes information on the remaining time until the traffic light 201 is changed from blue to yellow if the traffic light is currently blue, and information on the remaining time until the traffic light is changed next to blue when the traffic light is not currently blue.

The communication unit 11 is further capable of wirelessly communicating with other vehicles around the subject vehicle 100, and particularly, is capable of wirelessly communicating with the rearward vehicles 101, 102 (capable of inter-vehicle communication). The communication unit 11 receives vehicle information of the rearward vehicles 101, 102 by inter-vehicle communication. The vehicle information includes information on the lengths (total lengths) of the rearward vehicles 101, 102 stored in advance as information unique to the rearward vehicles 101, 102. When the rearward vehicles 101, 102 each have a position detector such as a GPS sensor, the vehicle information includes position information.

The positioning sensor 12 receives a positioning signal transmitted from a positioning satellite. The positioning satellite is an artificial satellite such as a global positioning system (GPS) satellite or a quasi-zenith satellite. The positioning information received by the positioning sensor 12 is used to measure the current position (latitude, longitude, and altitude) of the subject vehicle 100. The positioning sensor 12 is used to detect the position of the subject vehicle 100 (a distance to the traffic light 201 or the like) with respect to the position of the intersection where the traffic light 201 is installed. Therefore, instead of the positioning sensor 12, a distance detector (a radar, a LiDAR, or the like) that detects a distance from the subject vehicle 100 to a target object (an object near the intersection) may be used.

The distance detector 13 includes a LiDAR that detects the position (distance or direction from the subject vehicle 100) of an object around the subject vehicle 100 by emitting laser light and detecting reflected light, a radar that detects the position of an object around the subject vehicle 100 by emitting electromagnetic waves and detecting reflected waves, and the like. The distance detector 13 is provided on the rear side of the subject vehicle 100 and detects a distance from the subject vehicle 100 to the rearward vehicle 101. The rearward vehicles 101, 102 also have similar distance detectors to detect the inter-vehicle distance between the rearward vehicle 101 and the rearward vehicle 102.

The monitor 14 is provided at an instrument panel at a front portion of the vehicle interior, and provides various types of information to the driver. A display of a navigation unit arranged in the vicinity of the instrument panel can also be used as the monitor 14. A head-up display that projects an image onto a windshield or a panel provided near the windshield may be configured as the monitor 14.

The controller 20 executes predetermined processing on the basis of signals from the communication unit 11, the positioning sensor 12, and the distance detector 13, and outputs a control signal to the monitor 14. The controller (electronic control unit) 20 includes a computer having other peripheral circuits such as a CPU, a ROM, a RAM, and an I/O interface. The controller 20 includes, as functional components, an information acquisition unit 21, a length calculation unit 22, a driving derivation unit 23, a notification control unit 24, and an output unit 25.

The information acquisition unit 21 acquires the traffic light information and the vehicle information of the rearward vehicles 101, 102 received by the communication unit 11, and the information (position information) of the current position of the subject vehicle 100 detected by the positioning sensor 12. That is, the information acquisition unit 21 functions as a traffic light information acquisition unit that acquires traffic light information, a position information acquisition unit that acquires position information of the subject vehicle 100, and a rearward vehicle information acquisition unit that acquires vehicle information of the rearward vehicles 101, 102 (rearward vehicle information).

The length calculation unit 22 calculates an entire length L0 from the front end of the subject vehicle 100 to the rear end of the rearward vehicle 102 located at the rear end of the vehicle group 110. FIG. 4 is a diagram schematically illustrating the entire length L0. As illustrated in FIG. 4, the entire length L0 is calculated by adding up a length L1 of the subject vehicle 100, an inter-vehicle distance ΔL from the subject vehicle 100 to the rearward vehicle 102, and a length L2 of the rearward vehicle 102. The length L1 is stored in advance in the memory. The length L2 is included in the vehicle information of the rearward vehicle 102 acquired via the communication unit 11.

The inter-vehicle distance ΔL is calculated by adding up an inter-vehicle distance ΔL1 from the subject vehicle 100 to the rearward vehicle 101 detected by the distance detector 13, a length ΔL2 included in the vehicle information of the rearward vehicle 101 acquired via the communication unit 11, and an inter-vehicle distance ΔL3 between the rearward vehicles 101, 102 detected by the rearward vehicles 101, 102 and acquired via the communication unit 11. The length ΔL2 and inter-vehicle distance ΔL3 of rearward vehicle 101 are acquired by the information acquisition unit 21 (rearward vehicle information acquisition unit). The inter-vehicle distance ΔL is not constant and varies depending on acceleration/deceleration of the subject vehicle 100 or the like. Such the vehicle group 110 including the subject vehicle 100 and the rearward vehicles 101, 102 can be regarded as one large vehicle (for example, trailer) 110a. If the rearward vehicles 101, 102 include positioning sensors such as GPS sensors, the inter-vehicle distance ΔL may be calculated by acquiring position information of the rearward vehicles 101, 102 detected by the positioning sensors.

A rearward vehicle assumed by the driving assist apparatus according to the present embodiment is the rearward vehicle 101 in which an inter-vehicle distance (first inter-vehicle distance) ΔL1 between the subject vehicle 100 and the rearward vehicle 101 is within a first predetermined distance ΔLa. Further, another rearward vehicle assumed by the driving assist apparatus according to the present embodiment is the rearward vehicle 102 in which the inter-vehicle distance (second inter-vehicle distance) ΔL3 between the rearward vehicle 101 and the rearward vehicle 102 is within a second predetermined distance ΔLb. That is, the rearward vehicles are rearward vehicles that satisfy the following inter-vehicle distance conditions ΔL1≤ΔLa and ΔL3≤ΔLb. Therefore, when the inter-vehicle distance ΔL1 becomes larger than the first predetermined distance ΔLa, the rearward vehicle 101 is no longer regarded as a rearward vehicle following the subject vehicle 100, and the driving assist information is not transmitted to the rearward vehicles 101, 102 by the output unit 25 described later. When the inter-vehicle distance ΔL3 becomes larger than the second inter-vehicle distance ΔLb, the rearward vehicle 102 is no longer regarded as a rearward vehicle following the rearward vehicle 101, and the driving assist information is not transmitted to the rearward vehicle 102. The first predetermined distance ΔLa and the second predetermined distance ΔLb are equal, for example. The first predetermined distance ΔLa may be longer or shorter than the second predetermined distance ΔLb.

The driving derivation unit 23 derives recommended driving for the driver based on the traffic light information and the position information acquired by the information acquisition unit 21 and the entire length L0 calculated by the length calculation unit 22. Specifically, the driving derivation unit 23 calculates the distance from the subject vehicle 100 to the intersection where the traffic light 201 is installed using the position information, and calculates the range of target vehicle speed at which the vehicle group 110 including the subject vehicle 100 can pass through the intersection without stopping, based on the distance, the entire length L0 of the vehicle group 110, and the remaining time until the traffic light 201 in front of the subject vehicle 100 included in the traffic light information changes from blue to yellow. That is, the driving derivation unit 23 calculates the range of target vehicle speed in which not only the subject vehicle 100 but also the rearward vehicle 101, 102 can pass through the intersection. The range of target vehicle speed is included in the recommended driving for the driver.

On the other hand, when determining that the vehicle group 110 cannot pass through the intersection without stopping, for example, when determining that the subject vehicle 100 cannot pass through or the subject vehicle 100 can pass through but the rearward vehicle 102 cannot pass through, the driving derivation unit 23 calculates the range of target vehicle speed for the subject vehicle 100 to smoothly stop in front of the traffic light 201. Then, if the current vehicle speed of the subject vehicle 100 exceeds the target vehicle speed, the driving derivation unit 23 derives a deceleration command for recommended driving.

The notification control unit 24 controls the monitor 14 to display the information on the recommended driving derived by the driving derivation unit 23, that is, the drive assist information. For example, the notification control unit 24 controls the monitor 14 to display an image of a target vehicle speed for passing through an intersection without stopping at the intersection, and to display an image of a deceleration command when it is necessary to stop at the intersection.

The output unit 25 transmits the driving assist information provided to the driver to the vehicle-mounted devices 101a, 102a of the rearward vehicles 101, 102 via the communication unit 11. The transmitted information includes subject vehicle information including that the subject vehicle 100 has the driving assist function from which the driving assist information is derived. The transmitted information is displayed on, for example, the monitors of the rearward vehicles 101, 102, and thus, the drivers of the rearward vehicles 101, 102 can recognize the reason for the current traveling mode of the forward vehicle (subject vehicle 100). For example, the drivers of the rearward vehicles 101, 102 can recognize that the subject vehicle 100 decelerates in anticipation of change of the traffic light 201 from blue to red.

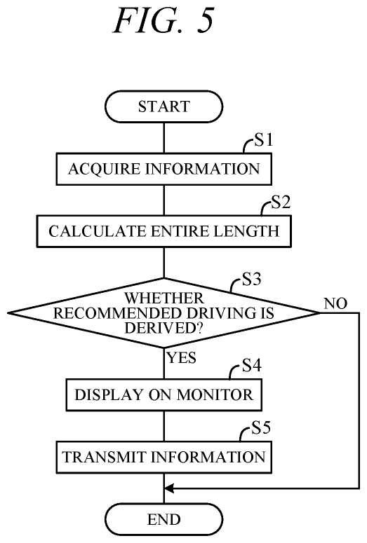

FIG. 5 is a flowchart illustrating an example of processing executed by the controller 20 of FIG. 3. The processing illustrated in the flowchart is started when the controller 20 detects, for example, that the rearward vehicles 101, 102 capable of inter-vehicle communication with the subject vehicle 100 are traveling behind the subject vehicle 100, and is repeated at a predetermined cycle corresponding to the operation cycle of the computer.

First, in S1 (S: processing step), the controller 20 acquires the traffic light information and the rearward vehicle information via the communication unit 11, and acquires the position information obtained by the positioning sensor 12. The controller 20 determines whether the rearward vehicles 101, 102 satisfy the inter-vehicle distance conditions (ΔL1≤ΔLa, ΔL3≤ΔLb), and acquires the rearward vehicle information from the rearward vehicles 101, 102 satisfying the inter-vehicle distance conditions. Next, in S2, the controller 20 calculates the entire length L0 from the front end of the subject vehicle 100 to the rear end of the rearward vehicle 102 located at the rear end of the vehicle group 110 using the lengths of the rearward vehicles 101, 102 included in the rearward vehicle information.

Next, in S3, the controller 20 determines whether the recommended driving for the driver is derived. When the subject vehicle 100 passes through the traffic light 201, the recommended driving is derived based on the traffic light information. Therefore, the determination in S3 corresponds to the determination on whether the subject vehicle 100 is approaching the traffic light 201. If the determination is in the affirmative in S3, the process proceeds to S4, and if the determination is in the negative, the process passes S4 and S5 and is ended.

In S4, the controller 20 outputs a control signal to the monitor 14 so that information on recommended driving such as a target vehicle speed and a deceleration command, that is, driving assist information is displayed on the monitor 14. Next, in S5, the controller 20 transmits the driving assist information displayed on the monitor 14 to the vehicle-mounted devices 101a, 102a of the rearward vehicles 101, 102 via the communication unit 11, and ends the processing.

The operation of the driving assist apparatus 10 according to the present embodiment will be described more specifically. As illustrated in FIG. 2A, when the subject vehicle 100 and the rearward vehicles 101, 102 following the subject vehicle 100 are traveling as the vehicle group 110, the target vehicle speed is displayed on the monitor 14 of the subject vehicle 100 based on the traffic light information (S4). The target vehicle speed is a vehicle speed at which the subject vehicle 100 to the rearward vehicle 102 can pass through the intersection without stopping, and is calculated based on the entire length L0 of the vehicle group 110. This allows the rearward vehicles 101, 102 to travel in anticipation of a change in the traffic light 201 in the same manner as having the driving assist function based on the traffic light information although they do not have the driving assist function.

On the other hand, even if the traffic light 201 is currently blue, when it is determined that the traffic light 201 will change to yellow or red before the vehicle group 110 passes through the intersection, a deceleration command is displayed on the monitor 14 of the subject vehicle 100 (S4). At this time, driving assist information of the deceleration command for the subject vehicle 100 is transmitted to the vehicle-mounted devices 101a, 102a of the rearward vehicles 101, 102 (S5). Accordingly, when the subject vehicle 100 is decelerated, the drivers of the rearward vehicles 101, 102 can recognize the reason and perform the driving operation without feeling a sense of strangeness.

In this case, when the drivers of the rearward vehicles 101, 102 recognize that the deceleration command is output to the driver of the subject vehicle 100, the rearward vehicle 102 first starts deceleration and then the entire vehicle group 110 decelerates while securing the inter-vehicle distances. The monitor 14 of the subject vehicle 100 also displays information on the remaining time until the traffic light 201 changes to blue while the subject vehicle 100 is stopped at the red light. This information is also transmitted to the vehicle-mounted devices 101a, 102a of the stopped rearward vehicles 101, 102 via the communication unit 11. Accordingly, when the traffic light 201 changes from red to blue, the subject vehicle 100 and the rearward vehicles 101, 102 can simultaneously start, thereby enabling smooth start of the vehicle group 110.

The present embodiment can achieve advantageous effects as follows:

(1) The driving assist apparatus 10 includes the communication unit 11; the information acquisition unit 21 (traffic light information acquisition unit, rearward vehicle information acquisition unit, and position information acquisition unit) that acquires, via the communication unit 11, the traffic light information including change information of the traffic light 201 and rearward vehicle information including length information of rearward vehicles 101, 102 traveling behind the subject vehicle 100, and acquires the position information indicating the position of the subject vehicle 100 with respect to the traffic light 201; the length calculation unit 22 that calculates the entire length L0 from the front end of the traveling subject vehicle 100 to the rear end of the traveling rearward vehicle 102 on the basis of the length information of the rearward vehicle 102 acquired by the information acquisition unit 21; the driving derivation unit 23 that derives the driving assist information including the target vehicle speed or target acceleration of the subject vehicle 100 for the entire vehicle including the subject vehicle 100 and the rearward vehicles 101, 102 to pass through the intersection where the traffic light 201 is installed or stop in front of the intersection, on the basis of the traffic light information and position information acquired by the information acquisition unit 21 and the entire length L0 calculated by the length calculation unit 22; and the output unit 25 that transmits the driving assist information provided to the driver of the subject vehicle 100 to the rearward vehicles 101, 102 via the communication unit 11 (FIG. 3).

With this configuration, the drivers of the rearward vehicles 101, 102 can notice that the subject vehicle 100 is driven based on the traffic light information. As a result, when the subject vehicle 100 is decelerated even though the traffic light 201 in front is blue, it is possible to prevent the drivers of the rearward vehicles 101, 102 from feeling a sense of strangeness. Therefore, the rearward vehicles 101, 102 that do not have the driving assist function based on the traffic light information travel following the subject vehicle 100 that has the driving assist function based on the traffic light information, so that, similarly to the subject vehicle 100, the rearward vehicles 101, 102 can smoothly travel at the intersection where the traffic light 201 is installed without feeling a sense of strangeness.

(2) The driving assist apparatus 10 further includes the monitor 14 that notifies the driver of the subject vehicle 100 of the driving assist information derived by the driving derivation unit 23 (FIG. 3). This allows the driver of the subject vehicle 100 to easily recognize the target vehicle speed and the like for the entire vehicle group 110 including the subject vehicle 100 and the rearward vehicles 101, 102 to pass through the intersection. As a result, the subject vehicle 100 and the rearward vehicles 101, 102 can integrally pass through the intersection where the traffic light 201 is installed in a manner as if the subject vehicle 100 and the rearward vehicles 101, 102 were one large vehicle 110a.

(3) The subject vehicle information transmitted by the output unit 25 via the communication unit 11 includes the driving assist information derived by the driving derivation unit 23. This allows to the drivers of the rearward vehicles 101, 102 can perform the acceleration/deceleration operations of the rearward vehicles 101, 102 at appropriate timings.

The above embodiment may be modified into various forms. Hereinafter, some modifications will be described. In the above embodiment, the information acquisition unit 21 acquires the traffic light information, the position information, and the rearward vehicle information. However, the configuration of the information acquisition unit 21, that is, the configurations of a traffic light information acquisition unit, position information acquisition unit, and rearward vehicle information acquisition unit are not limited to those described above. That is, the traffic light information acquisition unit may have any configuration as long as it acquires the traffic light information including the change information of the traffic light 201 via the communication unit 11. The position information acquisition unit may have any configuration as long as it acquires the position information indicating the position of the subject vehicle 100 with respect to the traffic light 201. The rearward vehicle information acquisition unit may have any configuration as long as it acquires the rearward vehicle information including the length information of the rearward vehicles 101, 102 traveling behind the subject vehicle 100 via the communication unit 11.

In the above embodiment, the information acquisition unit 21 acquires the traffic light information on the traffic light installed at the intersection. However, the traffic light information may be information on a traffic light at a crosswalk or the like, and the location where the traffic light is provided is not limited to the intersection. In the above embodiment, the driving derivation unit 23 derives recommended driving for the driver based on the traffic light information and the position information of the subject vehicle 100 acquired by the information acquisition unit 21 and the entire length of the vehicle group 110 calculated by the length calculation unit 22. Specifically, the driving derivation unit 23 derives the driving assist information including the target vehicle speed and the target acceleration. However, other recommended driving such as a lane change command may be derived, and the configuration of a derivation unit is not limited to the above-described one.

In the above embodiment, the output unit 25 transmits the driving assist information provided to the driver of the subject vehicle 100 to the rearward vehicles 101, 102 via the communication unit 11. However, if transmitting the subject vehicle information including that the subject vehicle has the driving assist function capable of deriving the driving assist information, to the rearward vehicles 101, 102 via the communication unit 11, the output unit 25 may also transmit other information together. Therefore, the subject vehicle information transmitted to the rearward vehicles 101, 102 is not limited to the above-described one, and the configuration of the output unit 25 is also not limited to the above-described one. In the above embodiment, the notification control unit 24 notifies the driver of the driving assist information derived by the driving derivation unit 23 via the monitor 14. However, the driver may be provided with the driving assist information by audio output or the like, and the configuration of s notification unit is not limited to the above-described one.

In the above embodiment, the subject vehicle 100 is configured as a manual driving vehicle, but may be configured as a self-driving vehicle having self-driving capability. In this case, the controller 20 may control the traveling operation of the subject vehicle 100 according to the driving assist information, and may not display the driving assist information on the monitor 14.

The present invention can be also used as a driving assist method including: acquiring a traffic light information including a change information of a traffic light 201 through a communication unit 11; acquiring a position information indicating a position of a subject vehicle with respect to the traffic light 201; acquiring a rearward vehicle information including a length information of a rearward vehicle traveling behind the subject vehicle through the communication unit 11; calculating an entire length from a front end of the subject vehicle to a rear end of the rearward vehicle, based on the length information of the rearward vehicle; deriving a driving assist information including a target vehicle speed or a target acceleration of the subject vehicle so that a group of vehicles including the subject vehicle and the rearward vehicle passes through a point where the traffic light 201 is provided or stops in front of the point, based on the traffic light information, the position information and the entire length; and transmitting a subject vehicle information indicating that the subject vehicle has a driving assist function capable of deriving the driving assist information, to the rearward vehicle through the communication unit 11.

The above embodiment can be combined as desired with one or more of the above modifications. The modifications can also be combined with one another.

According to the present invention, it is possible to prevent a driver of a rearward vehicle not having a driving assist function based on a traffic light information, from feeling uncomfortable due to a movement of a forward vehicle.

Above, while the present invention has been described with reference to the preferred embodiments thereof, it will be understood, by those skilled in the art, that various changes and modifications may be made thereto without departing from the scope of the appended claims.

What is claimed is:

1. A driving assist apparatus comprising:
a communication unit; and
an electronic control unit including a microprocessor and a memory connected to the microprocessor, wherein
the microprocessor is configured to perform:
acquiring a traffic light information including a change information of a traffic light through the communication unit;
acquiring a position information indicating a position of a subject vehicle with respect to the traffic light;
acquiring a rearward vehicle information including a length information of a rearward vehicle traveling behind the subject vehicle through the communication unit;
calculating an entire length from a front end of the subject vehicle to a rear end of the rearward vehicle, based on the length information of the rearward vehicle;
deriving a driving assist information including a target vehicle speed or a target acceleration of the subject vehicle so that a group of vehicles including the subject vehicle and the rearward vehicle passes through a point where the traffic light is provided or stops in front of the point, based on the traffic light information, the position information and the entire length; and
transmitting a subject vehicle information indicating that the subject vehicle has a driving assist function capable of deriving the driving assist information, to the rearward vehicle through the communication unit.

2. The driving assist apparatus according to claim 1, wherein
the microprocessor is configured to further perform
notifying a driver of the subject vehicle of the driving assist information.

3. The driving assist apparatus according to claim 1, wherein
the subject vehicle information transmitted through the communication unit includes the driving assist information.

4. The driving assist apparatus according to claim 1, further comprising
a distance detection device that detects a distance from the subject vehicle to the rearward vehicle, wherein
the microprocessor is configured to perform
the acquiring including acquiring the rearward vehicle information on the rearward vehicle when the distance detected by the distance detection device is equal to or shorter than a predetermined value.

5. The driving assist apparatus according to claim 4, wherein
the rearward vehicle includes a first rearward vehicle traveling behind the subject vehicle and a second rearward vehicle traveling behind the first rearward vehicle, and
the microprocessor is configure to perform
the acquiring including acquiring the rearward vehicle information on the first rearward vehicle and the second rearward vehicle when a first inter-vehicle distance from the subject vehicle to the first rearward vehicle is equal to or shorter than a first predetermined value and a second inter-vehicle distance from the first rearward vehicle to the second rearward vehicle is equal to or shorter than a second predetermined value.

6. A driving assist apparatus comprising:
a communication unit; and
an electronic control unit including a microprocessor and a memory connected to the microprocessor, wherein
the microprocessor is configured to function as:
a traffic light information acquisition unit that acquires a traffic light information including a change information of a traffic light through the communication unit;
a position information acquisition unit that acquires a position information indicating a position of a subject vehicle with respect to the traffic light;
a rearward vehicle information acquisition unit that acquires a rearward vehicle information including a length information of a rearward vehicle traveling behind the subject vehicle through the communication unit;
a length calculation unit that calculates an entire length from a front end of the subject vehicle to a rear end of the rearward vehicle, based on the length information of the rearward vehicle acquired by the rearward vehicle information acquisition unit;
a derivation unit that derives a driving assist information including a target vehicle speed or a target acceleration of the subject vehicle so that a group of vehicles including the subject vehicle and the rearward vehicle passes through a point where the traffic light is provided or stops in front of the point, based on the traffic light information acquired by the traffic light information acquisition unit, the position information acquired by the position information acquisition unit, and the entire length calculated by the length calculation unit; and
an output unit that transmits a subject vehicle information indicating that the subject vehicle has a driving assist function capable of deriving the driving assist information, to the rearward vehicle through the communication unit.

7. The driving assist apparatus according to claim 6, wherein
the microprocessor is configured to further function as
a notification unit that notifies a driver of the subject vehicle of the driving assist information derived by the derivation unit.

8. The driving assist apparatus according to claim 6, wherein
the subject vehicle information transmitted by the output unit through the communication unit includes the driving assist information derived by the derivation unit.

9. The driving assist apparatus according to claim 6, further comprising
a distance detection device that detects a distance from the subject vehicle to the rearward vehicle, wherein
the rearward vehicle information acquisition unit acquires the rearward vehicle information on the rearward vehicle when the distance detected by the distance detection device is equal to or shorter than a predetermined value.

10. The driving assist apparatus according to claim 9, wherein
the rearward vehicle includes a first rearward vehicle traveling behind the subject vehicle and a second rearward vehicle traveling behind the first rearward vehicle, and
the rearward vehicle information acquisition unit acquires the rearward vehicle information on the first rearward vehicle and the second rearward vehicle when a first inter-vehicle distance from the subject vehicle to the first rearward vehicle is equal to or shorter than a first predetermined value and a second inter-vehicle distance from the first rearward vehicle to the second rearward vehicle is equal to or shorter than a second predetermined value.

11. A driving assist method comprising:
acquiring a traffic light information including a change information of a traffic light through a communication unit;
acquiring a position information indicating a position of a subject vehicle with respect to the traffic light;
acquiring a rearward vehicle information including a length information of a rearward vehicle traveling behind the subject vehicle through the communication unit;
calculating an entire length from a front end of the subject vehicle to a rear end of the rearward vehicle, based on the length information of the rearward vehicle;
deriving a driving assist information including a target vehicle speed or a target acceleration of the subject vehicle so that a group of vehicles including the subject vehicle and the rearward vehicle passes through a point where the traffic light is provided or stops in front of the point, based on the traffic light information, the position information and the entire length; and
transmitting a subject vehicle information indicating that the subject vehicle has a driving assist function capable of deriving the driving assist information, to the rearward vehicle through the communication unit.
